(19) United States
(12) Patent Application Publication
(10) Pub. No.: US 2022/0366400 A1
(43) Pub. Date: Nov. 17, 2022

(54) Payment Accessory Integration System for Mobile Computing Devices

(71) Applicant: ZEBRA TECHNOLOGIES CORPORATION, Lincolnshire, IL (US)

(72) Inventors: Mu-Kai Shen, Taipei (TW); Man-Ching Yen, Taipei (TW); Andrew Kim, Hawthorn Woods, IL (US); Carl DeGiovine, Sayville, NY (US); Peter Randall Daly, Poughkeepsie, NY (US); Robert K. Liao, South Setauket, NY (US); Ian R. Jenkins, Stony Brook, NY (US)

(21) Appl. No.: 17/403,505

(22) Filed: Aug. 16, 2021

Related U.S. Application Data
(60) Provisional application No. 63/189,587, filed on May 17, 2021.

(51) Int. Cl. G06Q 20/34; G06Q 20/32

(52) U.S. Cl. CPC G06Q 20/353; G06Q 20/322

(57) ABSTRACT

A system comprises: a payment accessory including: a payment accessory including: at least one payment data sensor, and an accessory housing defining a mounting interface carrying a set of electrical contacts; and an adapter including: an adapter housing defining (i) an accessory bay configured to removably receive the mounting interface of the payment accessory, and (ii) a device interface opposite the accessory bay, the device interface configured to couple the adapter to a mobile computing device to interconnect the electrical contacts of the mounting interface with the mobile computing device.

### CROSS-REFERENCE TO RELATED APPLICATIONS

This application claims priority from U.S. Provisional Application No. 63/189,587 filed May 17, 2021 and entitled “Payment Module”, the content of which is incorporated herein by reference.

### BACKGROUND

Mobile computing devices, such as smart phones and other general-purpose mobile computers, can be employed to collect payment information, e.g. from customers upon delivery of items to customer residences, in retail facilities, and the like. Enabling such mobile computing devices to collect and process payment information, however, may be time consuming and costly, e.g. due to certification requirements, additional hardware costs, and the like.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a mobile computing device viewed from the front.

FIG. 2. is a diagram of a mobile computing device viewed from the back.

FIG. 3 is a diagram of the mobile computing device of FIG. 2, with an adapter and payment accessory device removed therefrom.

FIG. 4 is a diagram of a payment accessory adapter.

FIG. 5 is a diagram of the adapter and payment accessory in a disassembled state.

FIG. 6 is a diagram of the payment accessory.

FIG. 7 is a diagram the adapter and payment accessory in an assembled state.

FIG. 8 is a schematic diagram of certain internal components of the adapter.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Various devices can be employed to collect payment information, e.g. from physical tokens such as credit cards, other computing devices with software-implemented wallets stored thereon, and the like. A payment device is further configured, following the collection of payment information, to process the payment information and/or communicate with a payment network to effect a transaction.

The above collection and processing of payment information can occur in a variety of contexts, including upon delivery of items, within retail facilities (e.g. as mobile point of sale terminals), and the like. In many of the above contexts, payment functionality may be required alongside other functionality, such as initiating transactions, updating delivery tracking and/or inventory data, and the like. In some cases, providing those functions as well as payment functionality involves providing an operator with two physically distinct devices—a general-purpose mobile computer such as a smart phone, and a dedicated payment device. The deployment of two distinct devices increases deployment costs, and may be inconvenient to the operator.

Although integrating payment functionality with a general-purpose mobile computer may alleviate the inconvenience noted above, the costs of producing the mobile computer may increase as a result. Further, devices that collect payment information may require certification (e.g. for conformance with industry standards relevant to secure handling of payment information). Integrating payment capabilities with a mobile computing device may therefore require that the device itself undergo time-consuming certification processes.

Discussed below are mechanisms for providing payment processing functionality to mobile computing devices with a greater level of integration than the physically distinct devices mentioned above, while mitigating the burdens of certification and other costs associated with the development and deployment of such devices. The above payment processing functionality, provided via a mobile computing device, may also be referred to as software PIN on commercial off-the-shelf (SPoC) functionality.

Examples disclosed herein are directed to a system, comprising: a payment accessory including: at least one payment data sensor, and an accessory housing defining a mounting interface carrying a set of electrical contacts; and an adapter including: an adapter housing defining (i) an accessory bay configured to removably receive the mounting interface of the payment accessory, and (ii) a device interface opposite the accessory bay, the device interface configured to couple the adapter to a battery well of a mobile computing device; and a set of connectors configured to interconnect the electrical contacts of the mounting interface with the mobile computing device.

Additional examples disclosed herein are directed to an adapter for integrating an accessory module with a mobile computing device, the adapter comprising: an adapter housing; an accessory bay on a first side of the adapter housing, the adapter accessory bay configured to removably receive a payment accessory; a first set of contacts in the adapter accessory bay, configured to electrically engage with the payment accessory; a device interface on a second side of the adapter housing opposite the accessory bay, the device interface configured to couple the adapter to a battery well of a the mobile computing device; a second set of contacts associated with the device interface, configured to electrically engage with corresponding contacts of the mobile computing device; and a set of connectors disposed within the housing and configured to interconnect the first and second sets of contacts.

Further examples disclosed herein are directed to a payment accessory, comprising: an accessory housing including an inner wall, an opposing outer wall, and a set of side walls joining the inner and outer walls a set of electrical contacts extending from the inner wall onto at least one of the side walls, the electrical contacts configured to connect the payment accessory with a mobile computing device; and at least one payment data sensor supported by the accessory housing.

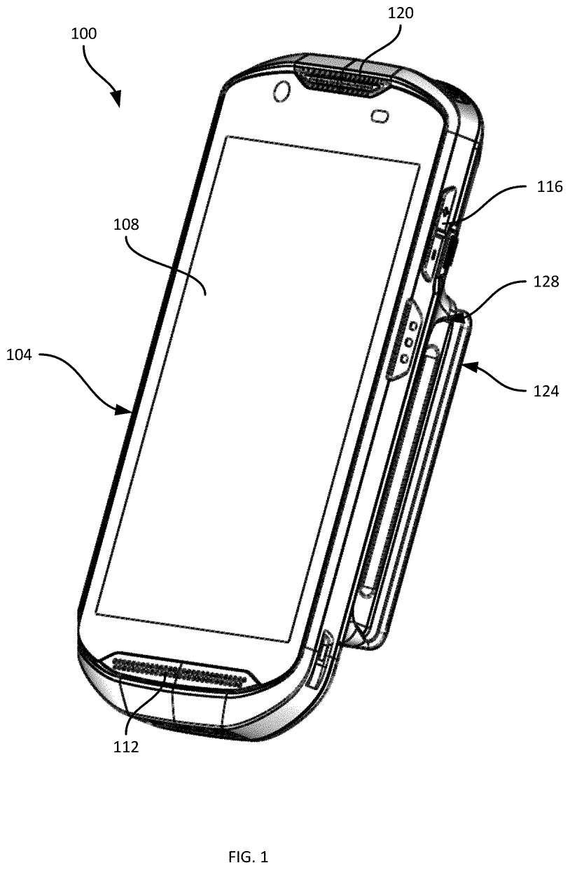

FIG. 1 illustrates mobile computing device 100, such as a smart phone or other mobile computer. The device 100 includes a housing 104 supporting various other components, including a display 108, which can include an integrated touch screen. The device 100 can include various other inputs, such as a microphone, buttons 116, and the like. The device 100 can also include additional outputs, such as a speaker 120.

The device 100, as will be apparent to those skilled in the art, includes a controller and associated storage device(s), e.g. in the form of a system-on-chip (SoC) or other suitable combination of integrated circuits and associated components. The controller can be configured to perform a wide variety of functionality by executing computer-readable instructions in the form of applications stored in the memory. Such functionality may not, however, include payment processing. Instead, the device 100 may execute one or more applications that call on payment processing functionality that is implemented by a payment accessory 124 that is removably coupled to the housing 104. As will be discussed in greater detail below, the accessory 124 is coupled to the housing 104 via an adapter 128 that is configured to engage with a battery well of the device 100. In other words, the accessory 124 can be readily attached and removed to and from the device 100. While attached to the device 100, the accessory 124 provides integrated SPoC functionality to the device 100, while mitigating the need to build such functionality into the device 100 itself (as well as certify the device for payment processing).

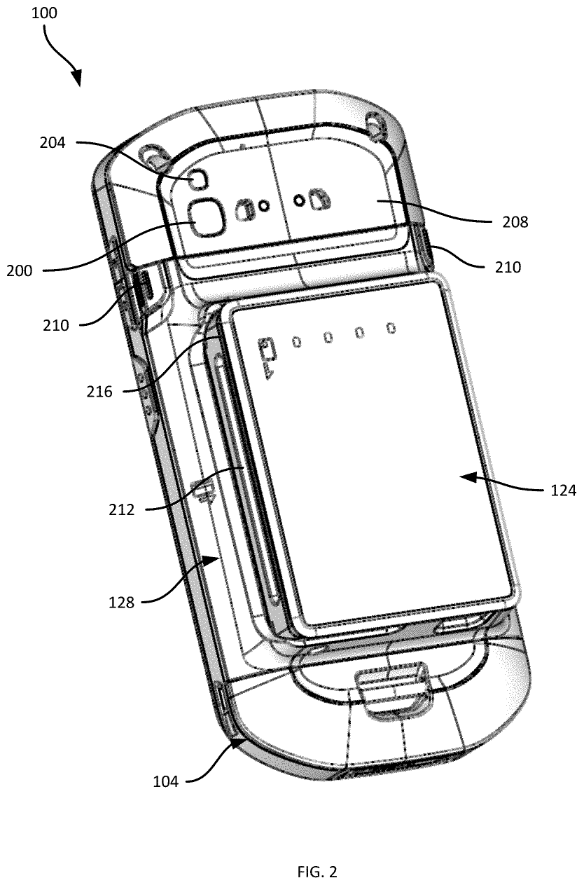

FIG. 2 shows a rear view of the device 100, which can carry additional components such as a camera 200 and associated flash 204. The payment accessory 124 and the adapter 128 are also shown in FIG. 2. In particular, the adapter 128 is configured to couple to the housing 104 such that the adapter 128 is substantially flush with a back surface 208 of the housing 104, and the payment accessory 124 is accessible from the back of the device 100. As will be discussed below, the adapter 128 includes a latching mechanism configured to removably affix the adapter 128 to the device housing 100. The latching mechanism can include, for example, one or more latch 210 that can be depressed towards one another to release the adapter 128 from the device housing 104.

The payment accessory 124 includes at least one payment data sensor, configured to collect payment data from a physical token such as a credit card or other payment card, another mobile device, or the like. In the illustrated example, the accessory 124 includes a card reader slot 212, e.g. to receive payment cards bearing cryptographic chips. The accessory 124 also includes a magnetic reader slot 216, e.g. to collect payment data from the magnetic strip on a payment card. The accessory 124 can also include, in addition to or instead of the above-mentioned sensors, a wireless communications interface such as an NFC reader for the collection of payment data.

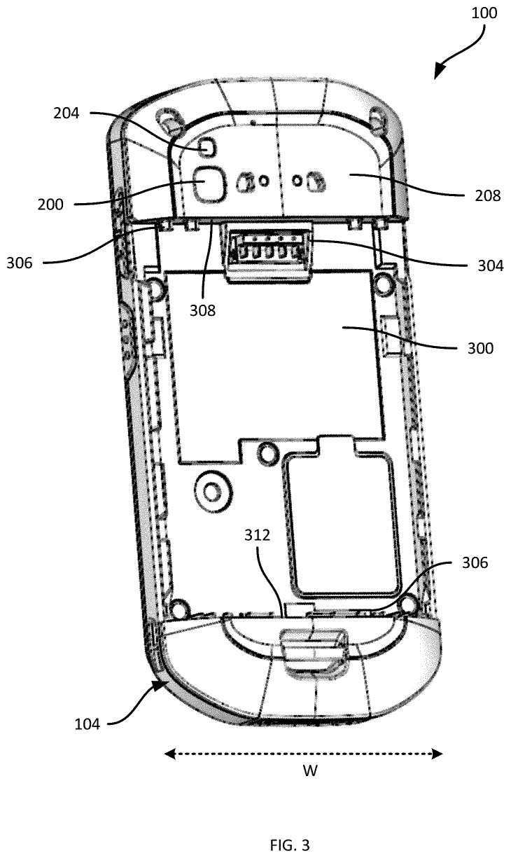

FIG. 3 illustrates the device 100 with the adapter 128 and the accessory 124 removed therefrom. As seen in FIG. 3, the device 100 includes a battery well 300, configured to receive a battery pack to supply power to the device 100. In the illustrated example, the battery well 300 is a depression that extends across the entire width “W” of the device 100. In other examples, however, the battery well 300 can have other shapes and sizes, including configurations in which the battery well 300 is a depression that spans less than the entire width W of the device 100.

Within the battery well 300, the device 100 includes a set of contacts 304, configured to enable at least power transmission between the battery pack and the remainder of the device 100. In the present example, the contacts 304 also enable data exchange with the primary controller of the device 100. For example, battery packs may include integrated controllers configured to control battery operations and convey battery status and/or other information to the primary controller of the device 100. The contacts 304 can therefore allow both power delivery and control and/or status data. For example, the contacts 304 can implement a universal serial bus (USB) pinout.

The battery well 300 also includes hooks 306 or other latching elements configured to engage with the latching mechanism of the adapter 128 (or of a battery pack, when a battery pack is placed in the battery well 300 instead of the adapter 128). In the illustrated example, the battery well 300 includes hooks 306 at both an upper wall 308 and a lower wall 312 of the battery well 300. In some examples, the latching elements can be disposed elsewhere on the device 100, as opposed to in the battery well 312.

As will be seen below, the adapter 128 enables the removable integration of the payment accessory 124 to the device 100 by making use of the battery well 300, such that the device 100 can be used with or without the payment accessory 124 while minimizing or eliminating the need for physical changes to the housing 104.

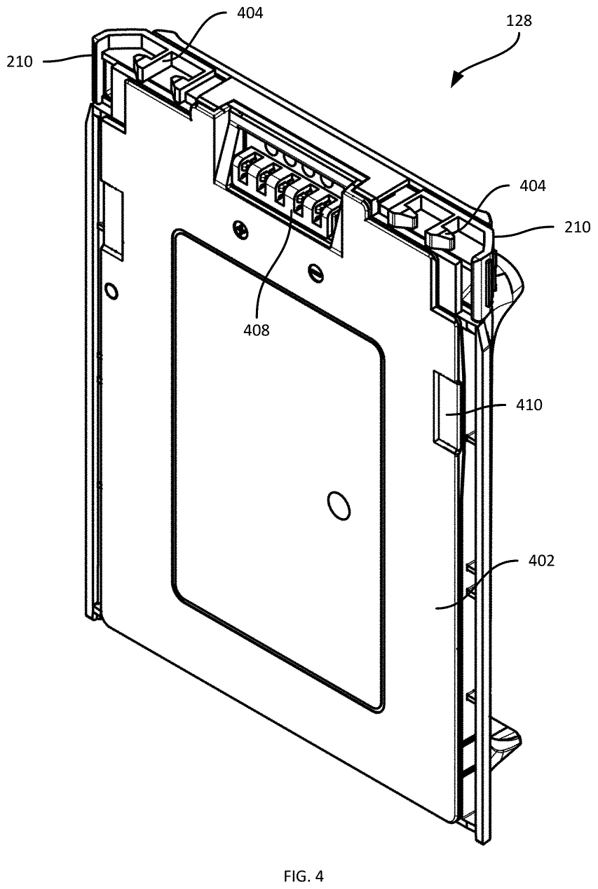

Turning to FIG. 4, the adapter 128 is shown in isolation. In particular, the adapter 128 includes a housing 400 with an inner side, e.g. defined by a substantially planar inner wall 402. The inner wall is referred to as “inner” because when the adapter 128 is installed on the device 100 (i.e. in the battery well 300), the inner wall 402 faces towards the device 100 (e.g. towards the display 108). The opposite side of the adapter 128 (not visible in FIG. 4), is therefore referred to as the outer side of the adapter 128. Similar nomenclature will also be used herein for certain portions of the payment accessory 124.

The adapter 128 includes movable latches 210 as shown in FIG. 2. As seen in FIG. 4, the latches 210 each include hooks 404 configured to engage with the hooks 306 on the upper wall 308 of the battery well 300. When the hooks 404 are engaged, the adapter 128 is retained within the battery well 300. Depression of the latches 210 disengages the hooks 404 from the hooks 306 and enables removal of the adapter 128 from the battery well 300.

The adapter 128 also includes a set of electrical contacts 408 on the inner wall 402, configured to engage with the contacts 304 in the battery well 300. The inner wall 402, along with the latches 210, may be referred to as a device interface of the adapter 128, in that the device interface mechanically couples the adapter 128 to the battery well 300 of the device 100, thereby placing the contacts 408 and 304 into engagement and allowing power and/or data exchange between the adapter 128 (as well as the payment accessory 124, when present) and the device 100. The adapter 128 can also include locating features in some examples, such as locating recesses 410 configured to engage with corresponding protrusions in the battery well 300.

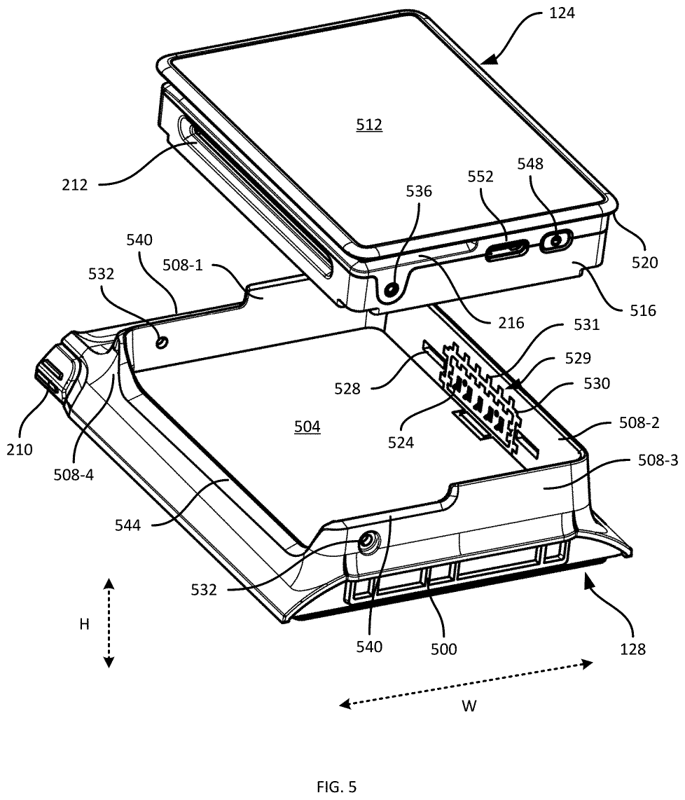

FIG. 5 illustrates the adapter 128 from an outer side thereof, along with the payment accessory 124 in a disassembled state. As seen in FIG. 5, the adapter 128 can also include static engagement features 500 at a lower end thereof (opposite the upper end, carrying the latches 210). The features 500 are configured to engage with the hooks 306 extending from the lower wall 312 of the battery well 300 to retain the adapter 128 within the well, in cooperation with the latches 210.

The adapter 128 includes an accessory bay on the outer side (opposite the inner side mentioned above), facing away from the device 100 when the adapter 128 is installed in the battery well 300. The accessory bay is configured to receive the payment accessory 124, and in this example includes a support surface 504 and a set of containment walls 508 extending outwards from the support surface 504. In this example, the adapter 128 includes four containment walls 508-1, 508-2, 508-3, and 508-4. In other examples, the number and shape of containment walls 508 may vary with the shape of the payment accessory 124.

As seen in FIG. 5, the support surface 504 and containment walls 508 form a bay, open at the outer side (i.e. the side facing away from the device 100), that can receive the payment accessory 124 therein. Specifically, the payment accessory 124 includes a housing with an outer wall 512, an opposing inner wall, and a set of side walls 516 joining the inner and outer walls. When the payment accessory 124 is inserted into the accessory bay of the adapter 128, the side walls 516 of the payment accessory 124 lie within the containment walls 508, and the lower wall of the payment accessory 124 rests on the support surface 504.

In the present example, the outer wall of the payment accessory 512 has a perimeter that is greater than the perimeter formed by the side walls 516, such that the outer wall 512 forms an overhang 520 with the side walls 516. The overhang 520 extends around at least a portion of the perimeter of the outer wall 512, and in the present example extends around the entire perimeter. When the accessory 124 is placed in the accessory bay of the adapter 128, the overhang 520 of the outer wall 512 rests on an upper edge of the containment walls 508. As a result, any impacts to the accessory 124 are transferred to the adapter 128 and device housing 104, rather than to the remainder of the accessory 124.

The accessory bay of the adapter 128 includes a set of contacts 524 configured to engage with corresponding contacts of the accessory 124 (not visible in FIG. 5). The contacts 524 are on a containment wall 508 in this example, but in other examples can be disposed on the support surface 504 instead of on a containment wall 508. For example, an adapter 128 configured for a different device model may have tighter constraints on the available width W, but looser constraints on available height H. Those constraints may be better accommodated by placing the contacts on the support surface 504 rather than the containment wall 508. The contacts 524 can be sealed to the housing of the adapter 128 (e.g. to the containment wall 508 in the illustrated example) by a seal 529, e.g. surrounding the contacts 524. In the present example, the seal 529 has a crenellated configuration to increase the area of engagement between the seal 529 and the containment wall 508. For example, the seal 529 can include a perimeter 530 surrounding the contacts 524, and one or more extensions 531 extending from the perimeter 530. The extensions 531 can have greater widths at the outer ends thereof in some examples.

To retain the accessory 124 within the accessory bay, the adapter 128 can include locating recesses 528 (two, in the illustrated example) on a containment wall 508, for receiving corresponding tabs on the accessory 124. The adapter 128 can also include apertures 532 in one or more of the containment walls 508, for receiving fasteners such as screws that traverse the apertures 532 and engage with the accessory 124, e.g. via openings 536. The fasteners can therefore lock the accessory 124 into the adapter 128, and/or prevent or discourage disassembly of the accessory 124 from the adapter 128.

In the illustrated example, to enable continued access to the slots 212 and 216 when the accessory 124 is installed in the accessory bay of the adapter 128, at least one of the containment walls 508 includes a cutout at an outer edge thereof. In particular, the walls 508-1 and 508-3 include cutouts 540 extending along a portion of the width of the adapter 128 to enable access to the slot 216. Further, the wall 508-4 includes a cutout 544 to enable access to the card slot 212. The cutout 544 extends along a majority of a length of the wall 508-4 in this example.

Although the walls 508 can include cutouts to enable access to payment data sensors of the accessory 124, the walls 508 can be configured to restrict access to other features of the accessory 124. For example, the accessory 124 can include a power button 548, and/or a port 552 for cabled connections to computing devices. When the accessory 124 is installed in the accessory bay, the containment wall 508-3 extends outwards to contact the outer wall 512 adjacent to the power button 548 and port 552, and therefore prevents access to the button 548 and port 552 while the accessory 124 is coupled to the adapter 128.

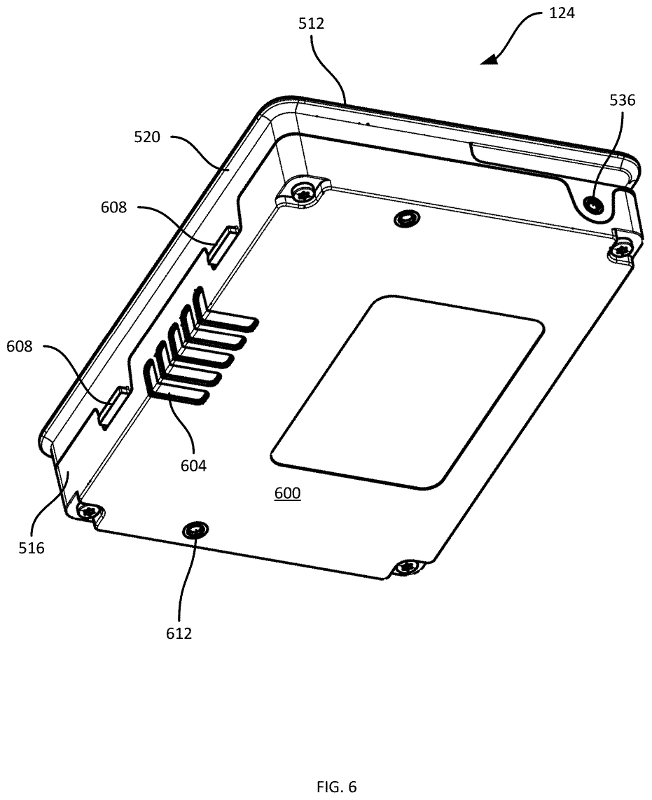

Turning to FIG. 6, certain additional features of the payment accessory 124 are illustrated. In particular, the inner side of the accessory 124 is shown, defined by an inner wall 600 opposite the outer wall 512. The accessory 124 includes a set of contacts 604 on either the inner wall 600, a side wall 516, or both. In the present example, the contacts 604 are implemented as conductive elements that extend from the inner wall 600 to a side wall 516, such that each contact covers a portion of both the inner wall 600 and the side wall 516. In this manner, the contacts 604 are compatible with adapters 128 having contacts 524 on a containment wall 508, as shown in FIG. 5, and adapters 128 having contacts 524 on the support surface 504, as mentioned above.

The accessory 124 can also include locating tabs 608 extending from a side wall 516, to engage with the recesses 528 shown in FIG. 5. In addition to the openings 536, the accessory 124 can also include additional openings 612 on the inner surface 600, e.g. to allow installation of the accessory 124 to other adapters.

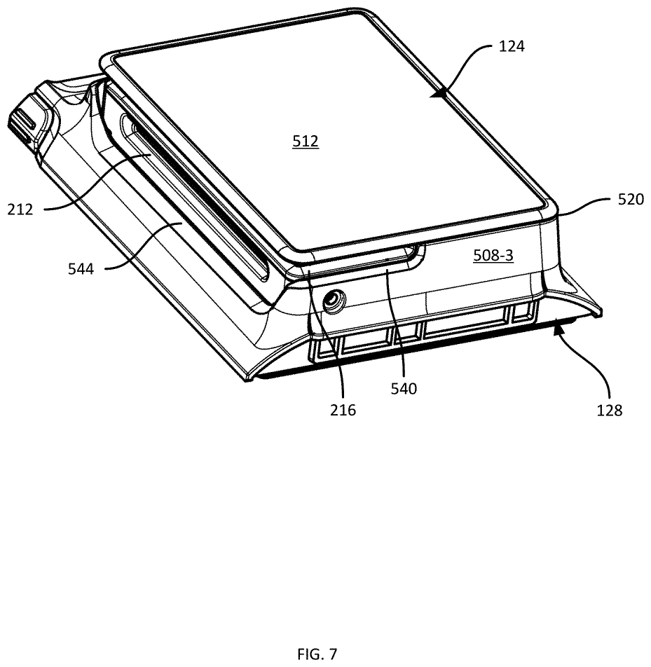

FIG. 7 illustrates the accessory 124 and the adapter 128 in an assembled state. As seen in FIG. 7, the overhang 520 rests on the walls 508, and the walls 508 prevent access to the power button 548 and port 552. The cutouts 540 and 544, however, enable continued access to the card slot 212 and 216.

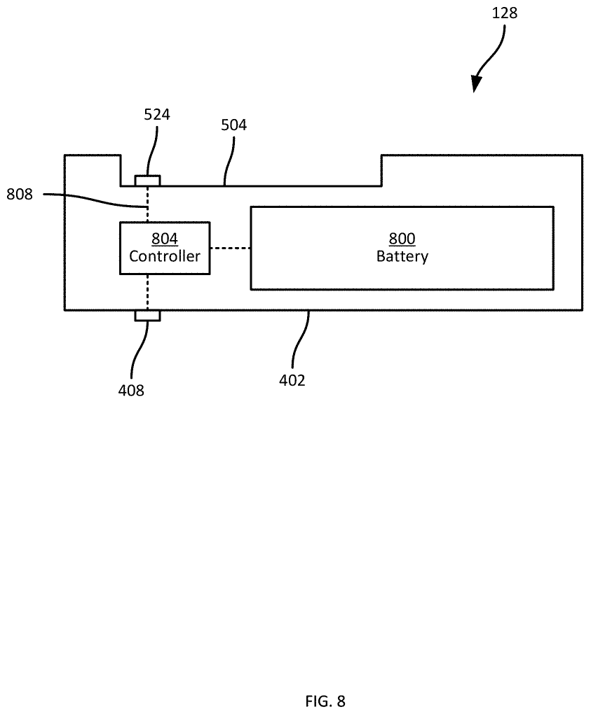

As will now be apparent, the adapter 128 may occupy a space on the device 100 that would otherwise be occupied by a battery pack. Therefore, the adapter 128 contains a battery, as well as the structural features described above enabling the adapter 128 to retain the payment accessory 124. In particular, the housing of the adapter can contain one or more battery cells (e.g. between the inner wall 402 and the support surface 504, as well as a charge controller or other suitable control component(s). Turning to FIG. 8, a schematic diagram of the adapter 128 is shown, including a battery 800 and controller 804 contained within the adapter housing. Connectors 808 traverse the housing between the contacts 408 and 524, as well as the controller 804 and/or the battery 800. The payment accessory 124 is therefore enabled to communicate with the device 100 via the contacts 524 and 408, as well as the connectors 808. Further, the accessory 124 can be supplied with electrical power from the battery 800, e.g. if the accessory 124 lacks an internal battery, or if such an internal battery is depleted. When the accessory 124 is supplied with electrical power from the battery 800, the supply of electrical power can be controlled by the device 100, rather than being drawn directed from the battery 800 by the accessory.

As will be apparent from the discussion above, the payment accessory 124 can therefore be used interchangeably with a wide variety of mobile computing devices 100. Thus, the development and certification process involved in deploying a payment processing device need only be performed once, and payment processing capabilities can be integrated into a number of distinct devices 100. Although a distinct adapter may be required for each device type, the cost of deploying adapters is generally lower than the cost of developing and certifying a payment processing device or payment processing functionality for a general-purpose computing device.

In other examples, the contacts 304 in the battery well 300 of the device may include only power-delivery contacts. In such examples, the device 100 can include a separate set of contacts for data delivery, e.g. on the back 208 of the device 100, side/and or end edges of the device 100, or the like. In such examples, the adapter 128 can include an extension that is placed over the separate set of contacts when the adapter 128 is placed in the battery well 300. The extension can carry a further set of data contacts, such that the adapter 128 can carry both power and data to the payment accessory 124. The adapter 128 can, in some examples, be implemented as a sled with contacts configured to engage with edge-mounted contacts of the device 100 as mentioned above. In further examples, the adapter 128 can secure the accessory 124 to the device 100 in a manner to place the contacts 604 directly against contacts of the device 100 itself (e.g. the contacts 304, or the contacts on a back or edge of the device 100 as mentioned above).

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A system, comprising:
a payment accessory including:
at least one payment data sensor, and
an accessory housing defining a mounting interface carrying a set of electrical contacts; and
an adapter including:
an adapter housing defining (i) an accessory bay configured to removably receive the mounting interface of the payment accessory, and (ii) a device interface opposite the accessory bay, the device interface configured to couple the adapter to a mobile computing device to interconnect the electrical contacts of the mounting interface with the mobile computing device.

2. The system of claim 1, wherein the accessory housing includes an inner wall, an opposing outer wall, and a set of side walls joining the inner and outer walls; and
wherein the electrical contacts are disposed on the inner wall and at least one of the side walls.

3. The system of claim 2, wherein the electrical contacts extend from the inner wall onto the at least one side wall.

4. The system of claim 2, wherein the accessory housing includes a locating tab extending from at least one of the side walls; and
wherein the accessory bay includes a recess configured to receive the locating tab.

5. The system of claim 2, wherein the adapter housing includes a set of containment walls extending outward from a support surface, defining the accessory bay; and
wherein the accessory bay includes adapter contacts configured to engage with the electrical contacts of the payment accessory.

6. The system of claim 5, wherein the adapter contacts are disposed on either (i) the support surface, or (ii) one of the containment walls.

7. The system of claim 5, wherein the perimeter of the outer wall of the accessory housing overhangs the side walls to engage with outer edges of the containment walls when the payment accessory is installed in the accessory bay.

8. The system of claim 5, wherein the at least one payment data sensor includes a card reader;
wherein the accessory housing defines a card slot associated with the card reader; and
wherein at least one of the containment walls includes a cutout enabling access to the card slot.

9. The system of claim 1, wherein the adapter housing defines a battery compartment containing a battery for the mobile computing device; and
wherein the set of connectors interconnect the mobile computing device with the battery and with the electrical contacts of the payment accessory.

10. The system of claim 1, wherein the device interface is configured to couple the adapter to a battery well of the mobile computing device.

11. The system of claim 10, wherein the device interface includes at least one latch to engage with the battery well of the mobile computing device.

12. An adapter for integrating an accessory module with a mobile computing device, the adapter comprising:
an adapter housing;
an accessory bay on a first side of the adapter housing, the accessory bay configured to removably receive a payment accessory;
a first set of contacts in the accessory bay, configured to electrically engage with the payment accessory;
a device interface on a second side of the adapter housing opposite the accessory bay, the device interface configured to couple the adapter to the mobile computing device;
a second set of contacts associated with the device interface, configured to electrically engage with corresponding contacts of the mobile computing device; and
a set of connectors disposed within the housing and configured to interconnect the first and second sets of contacts.

13. The adapter of claim 12, wherein the adapter housing contains a battery; and
wherein the connectors interconnect the first and second sets of contacts and the battery.

14. The adapter of claim 12, wherein the accessory bay includes a support surface defined on the first side of the adapter housing, and containment walls extending outward from the support surface.

15. The adapter of claim 14, wherein the first set of contacts is disposed on the support surface.

16. The adapter of claim 14, wherein the first set of contacts is disposed on one of the containment walls.

17. The adapter of claim 14, wherein at least one of the containment walls includes a cutout enabling access to a card slot of the payment accessory.

18. The adapter of claim 14, wherein at least one of the containment walls includes an aperture configured to receive a fastener therethrough to retain the payment accessory in the accessory bay.

19. The adapter of claim 12, wherein the device interface includes a latching mechanism disposed on the second side of the adapter housing.

20. The adapter of claim 12, wherein at least a portion of the accessory bay is configured to prevent access to an input mechanism of the payment accessory.

21. The adapter of claim 12, wherein the device interface is configured to couple the adapter to a battery well of the mobile computing device.

22. The adapter of claim 12, further comprising a seal surrounding the first set of contacts in the accessory bay.

23. A payment accessory, comprising:
an accessory housing including an inner wall, an opposing outer wall, and a set of side walls joining the inner and outer walls
a set of electrical contacts extending from the inner wall onto at least one of the side walls, the electrical contacts configured to connect the payment accessory with a mobile computing device; and
at least one payment data sensor supported by the accessory housing.

24. The payment accessory of claim 23, wherein a perimeter of the outer wall overhangs the side walls to engage with outer edges of containment walls of an accessory bay of the mobile computing device, when the payment accessory is installed in the accessory bay.
